(19) United States
(12) Patent Application Publication
(10) Pub. No.: US 2010/0250296 A1
(43) Pub. Date: Sep. 30, 2010

(54) CALIBRATION FRAMEWORK FOR EFFORT ESTIMATION

(75) Inventors: Kishore Channabasavaiah, Palatine, IL (US); Benjamin S. Gerber, Ann Arbor, MI (US); Sri Ramanathan, Lutz, FL (US); Matthew B. Trevathan, Kennesaw, GA (US); Raghu Varadan, San Francisco, CA (US); Revenko Zunic, Hopewell Junction, NY (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/410,509

(22) Filed: Mar. 25, 2009

(51) Int. Cl. G06Q 10/00; G06N 5/02

(52) U.S. Cl. 705/7; 706/46

(57) ABSTRACT

Methods, including service methods, articles of manufacture, systems, articles and programmable devices are provided for calibrating and customizing an estimation model as a function of a service-oriented architecture environment. A programmable calibration engine device configured by a logic component generates a service-oriented architecture solution effort estimate as a function of a business available resource input and a required business functionality input. Some methods also include managing a calibration constraint, a policy, an end-user access control, an output scope and an output format and providing a programmable effort estimation engine, providing a set of a predefined constraint, a boundary value and historical calibration data to the effort estimation engine, and generating a service-oriented architecture solution effort estimate as a function of the provided set, the policy and an input of a solution parameter within the scope of a service-oriented architecture transformation.

### FIELD OF THE INVENTION

The present invention generally describes methods, systems and devices for calibrating and customizing an estimation model as a function of a service-oriented architecture.

### BACKGROUND OF THE INVENTION

Service-Oriented Architecture (SOA) is a business-centric information technology (IT) architectural approach that supports integrating linked and repeatable business tasks or services. Generally, undertaking an SOA project in a business environment requires an initial estimate of the costs involved. However, current estimation techniques are inadequate for estimating the effort that is required for defining a SOA solution, a service design, and a service implementation and further fail to address SOA solutions or services-based estimations.

### SUMMARY OF THE INVENTION

Methods are provided for calibrating and customizing an estimation model as a function of a service-oriented architecture environment. A programmable calibration engine device configured by a logic component generates a service-oriented architecture solution effort estimate as a function of a business available resource input and a required business functionality input. Some methods also include managing a calibration constraint, a policy, an end-user access control, an output scope and an output format and providing a programmable effort estimation engine, providing a set of a predefined constraint, a boundary value and historical calibration data to the effort estimation engine, and generating a service-oriented architecture solution effort estimate as a function of the provided set, the policy and an input of a solution parameter within the scope of a service-oriented architecture transformation.

Service methods are also provided comprising deploying programmable devices or logic components or applications for calibrating and customizing an estimation model as a function of a service-oriented architecture environment according to the method steps described above, for example by a service provider who offers to implement, deploy, and/or perform functions for others. Still further, articles of manufacture comprising a computer usable medium having a computer readable program in said medium are provided. Such program code comprises instructions which, when executed on a computer system, cause the computer system to perform one or more method and/or process elements described above for calibrating and customizing an estimation model as a function of a service-oriented architecture environment. Moreover, systems, articles and programmable devices are also provided, configured for performing one or more method and/or process elements of the current invention for calibrating and customizing an estimation model as a function of a service-oriented architecture environment, for example as described above.

### BRIEF DESCRIPTION OF THE DRAWINGS

These and other features of the methods, systems and devices according to the present application will be more readily understood from the following detailed description of the various aspects of the embodiments taken in conjunction with the accompanying drawings in which:

FIG. 1 is a flow chart illustrating a method and system for calibrating and customizing an estimation model as a function of an SOA environment according to the present invention.

FIG. 2 is a diagrammatic illustration of an implementation of a method and system for calibrating and customizing an estimation model as a function of an SOA environment according to the present invention.

FIG. 3 is a block diagram of a system or device configured to calibrate and customize an estimation model as a function of an SOA environment according to the present invention.

FIG. 4 is a block diagram illustrating a computerized implementation of a method and system for calibrating and customizing an estimation model as a function of an SOA environment according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience the Detailed Description of the Invention has the following sections:

I. General Description; and

II. Computerized Implementation.

### I. General Description

Examples of SOA aspects and governance processes according to the present invention may be found in the following commonly-owned and co-pending U.S. patent applications or issued U.S. patents, the disclosures of which are expressly incorporated herein by reference: “Identifying a Service Oriented Architecture Shared Services Project”, attorney docket no. END920080252US1, filed on (to be provided), and assigned application serial no. (to be provided); “Evaluating a Service Oriented Architecture Shared Services Project”, attorney docket no. END920080288US1, filed on (to be provided), and assigned application serial no. (to be provided); “Service Oriented Architecture Shared Service Inception”, attorney docket no. END920080289US1, filed on (to be provided), and assigned application serial no. (to be provided); “Service Oriented Architecture Shared Services Elaboration”, attorney docket no. END920080290US1, filed on (to be provided), and assigned application serial no. (to be provided); “Service Oriented Architecture Shared Services Construction”, attorney docket no. END920080291US1, filed on (to be provided), and assigned application serial no. (to be provided); “Transitioning to Management of a Service Oriented Architecture Shared Service”, attorney docket no. END920080292US1, filed on (to be provided), and assigned application serial no. (to be provided); “Service Oriented Architecture Shared Service Management”, attorney docket no. END920080293US1, filed on (to be provided), and assigned application serial no. (to be provided); “Service Oriented Architecture Shared Service Escalation”, attorney docket no. END920080294US1, filed on (to be provided), and was assigned application serial no. (to be provided); “SOA Policy Versioning”, attorney docket no. END920080316US1-IEN106616, filed on (to be provided), and assigned application serial no. (to be provided); “FRAMEWORK FOR VARIATION ORIENTED ANALYSIS FOR SERVICE-ORIENTED ARCHITECTURE”, attorney docket no. END920080317US1-IEN106617, filed on (to be provided), and assigned application serial no. (to be provided); “TECHNICAL FEASIBILITY EXPLORATION FOR SERVICE-ORIENTED ARCHITECTURE ENVIRONMENTS”, attorney docket no. END920080318US1-IEN106618, filed on (to be provided), and assigned application serial no. (to be provided); “SOA Lifecycle Governance and Management”, attorney docket no. END920080319US1-IEN106619, filed on (to be provided), and assigned application serial no. (to be provided); “ENABLING SOA GOVERNANCE USING A SERVICE LIFECYCLE APPROACH”, attorney docket no. END920080320US1-IEN106620, filed on (to be provided), and assigned application serial no. (to be provided); “SERVICE PORTFOLIO APPROACH FOR SOA GOVERNANCE”, attorney docket no. END920080386US1-IEN106642, filed on (to be provided), and assigned application serial no. (to be provided); “SERVICE EVOLUTION APPROACH IN SOA”, attorney docket no. END920080387US1-IEN106643, filed on (to be provided), and assigned application serial no. (to be provided); “CAPABILITY AND MATURITY-BASED SOA GOVERNANCE”, attorney docket no. END920080388US1-IEN106644, filed on (to be provided), and assigned application serial no. (to be provided); “PRIORITIZATION ENABLEMENT FOR SOA GOVERNANCE”, attorney docket no. END920080389US1-IEN106645, filed on (to be provided), and assigned application serial no. (to be provided); and “SOA POLICY ENGINE FRAMEWORK”, attorney docket no. END920080390US1-IEN106646, filed on (to be provided), and assigned application serial no. (to be provided).

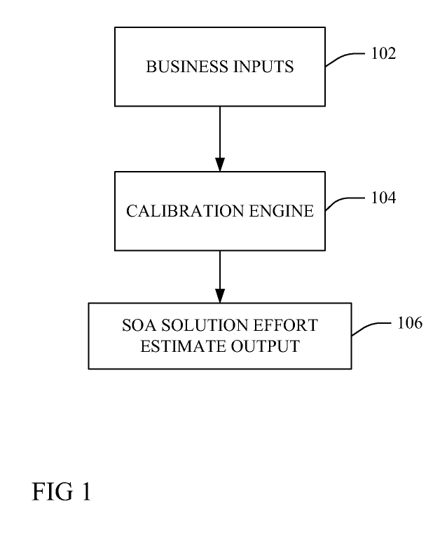

As SOA projects are increasingly considered and deployed, it has become evident that current, prior art estimation techniques are inadequate for estimating the effort that is required for defining SOA solutions, service design, and service implementation. More particularly, current estimation tools and techniques do not address SOA solutions, services based estimations, or include mechanisms for calibrating estimations. The present invention provides a framework for the design and realization of a calibration framework for effort estimation of software solution definition, design and implementation projects, one adaptable to implementing methods and tools for estimating complex projects and more specifically SOA transformation, definition, design and implementation projects. FIG. 1 is a high-level flow chart illustrating a method and system for calibrating and customizing an estimation model as a function of an SOA according to the present invention. A core element of the present calibration framework is a calibration engine 104 that leverages business inputs 102 to generate overall solution effort estimates 106.

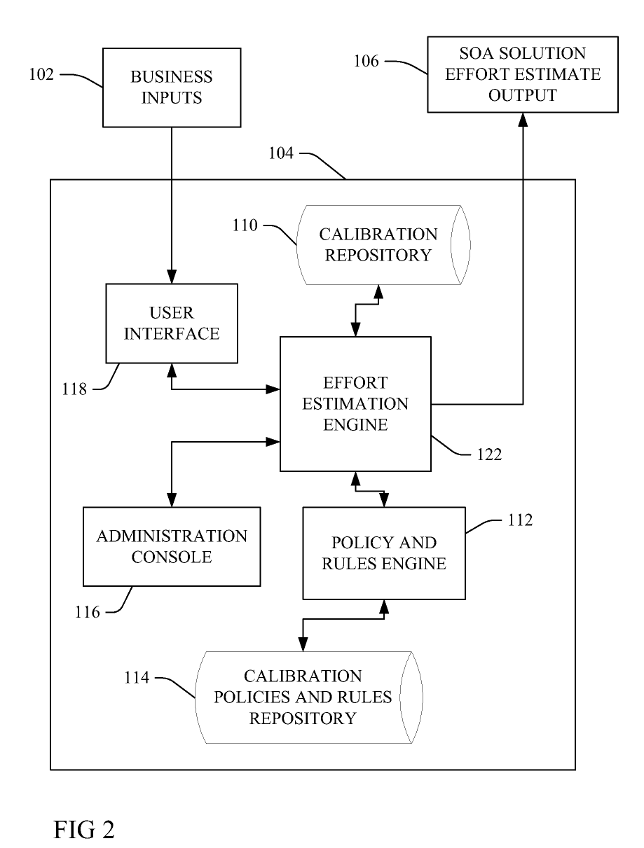

FIG. 2 is a block diagram illustrating one embodiment of the calibration engine 104 according to the present invention. The calibration engine 104 comprises an effort estimation engine 122 that functions as a core of the overall calibration engine framework 104 and is tightly coupled with a calibration information repository 110 comprising a set of predefined constraints, boundary values and historical calibration data essential for effort estimation. Illustrative but not exhaustive examples of calibration information repository 110 predefined constraints include limits and boundary values for the inputs that the engine can accept, for example a number of business processes, a number of business units, a budget, skilled resources, project duration, etc.

A policy and rules engine 112 leverages preset policies and rules available in an associated calibration policies and rules repository 114 and delivers the same to the calibration engine 104 on demand. The repository 114 preset policies and rules include details like a probable number of services for a given set of business processes, a probable number of resources for a given budget range, a probable duration required to deliver a range of services, etc. In one aspect including the policy and rules engine 112 as an integral module provide a rules-driven approach to estimation.

An administration console 116 enables setup and management of calibration constraints, defines and manage policies (e.g. through a policy authoring agent), defines and manages end-user access control, and/or defines and manages output scope and formats.

An interactive user interface module 118 may also be provided. In some embodiments the interface module 118 is realized by a set of dials, knobs, manually manipulated forms and other user interface components which enable an end-user to setup or input the parameters of a solution within the scope of an SOA transformation.

The calibration engine 104 generates an overall effort required for a given solution definition, design and implementation as a set of outputs 106 (e.g. screen displays on graphic display components of a audio/visual or computerized/programmable device, printed hard copy reports generated by a printing device, etc.). In some examples, outputs may comprise work-in-progress and final estimates, and the format and details of a given output 106 may be based on user provided and configurable parameters.

Illustrative but not exhaustive examples of parameters provided through the administration console 116 include calibration rules and policies; access policies; historical values; calibration constraints; and pre-configured output categories parameters (e.g. roles, effort, durations, etc.) used by the effort estimation engine 122 to format outputs 106.

SOA calibration frameworks and designs according to the present invention provide estimation models by which enterprises may calibrate and customize estimation models to suit a particular SOA environment. For example, the calibration engine model 104 is configured to take into consideration numerous factors that are not used in the prior art, thereby delivering more precise and accurate effort estimates and for a SOA project. Increasing estimate precision and accuracy translates to fewer troubled projects and a higher confidence in attaining committed delivery dates. In one aspect, the calibration engine model 104 may be considered an adaptive learning estimation model.

One intent of calibration frameworks according to the present invention is to provide an interactive environment for SOA effort estimation wherein end-users may vary a number of related inputs that influence the overall effort required for an SOA transformation initiative, further visualizing outputs 106 in near real-time. Illustrative but not exhaustive examples of related inputs include a like number of business processes, a number of business use cases, a number of cross-business entities, an available budget, an expected duration, an organizational skill, etc. Thus, tools, processes and methods implemented based on a framework according to the present invention enable end-users to effectively plan the scope of the SOA transformation initiative based on available resources and required business functionality.

Calibration frameworks according to the present invention may also be leveraged to implement other calibration-based SOA effort estimation tools or to enhance existing estimation tools to extend their capabilities to deliver SOA effort estimation capabilities. In addition, calibration frameworks may also be leveraged to develop methods and processes for effort estimation according to the present invention.

The present calibration engine attributes and implemented tools may be used in a number of flexible ways. End-users may set-up some input attributes as constants and vary others, thereby providing a range of inputs to the engine at 102. Users may thus view an overall effort estimate output at 106 for a given set of input values and attributes at 102. Moreover, variations of these different inputs at 102 may result in a number of alternative estimate outputs at 106 which enabling business executives, program managers, and other end-users to plan for a plurality or range of possible output effort estimates at 106, for example determining a scope of estimated results useful for planning for a SOA transformation initiative.

In contrast to the prior art, the present invention leverages calibration techniques for effort estimation; provides mechanisms for varying input parameters to model efforts required for SOA transformation initiatives or for other types of software engineering and development efforts; includes capabilities to configure and preset boundary values for effort estimation; leverages a policy and rules engine for effort estimation; and enables modeling of effort under varying conditions to determine scope in a interactive fashion.

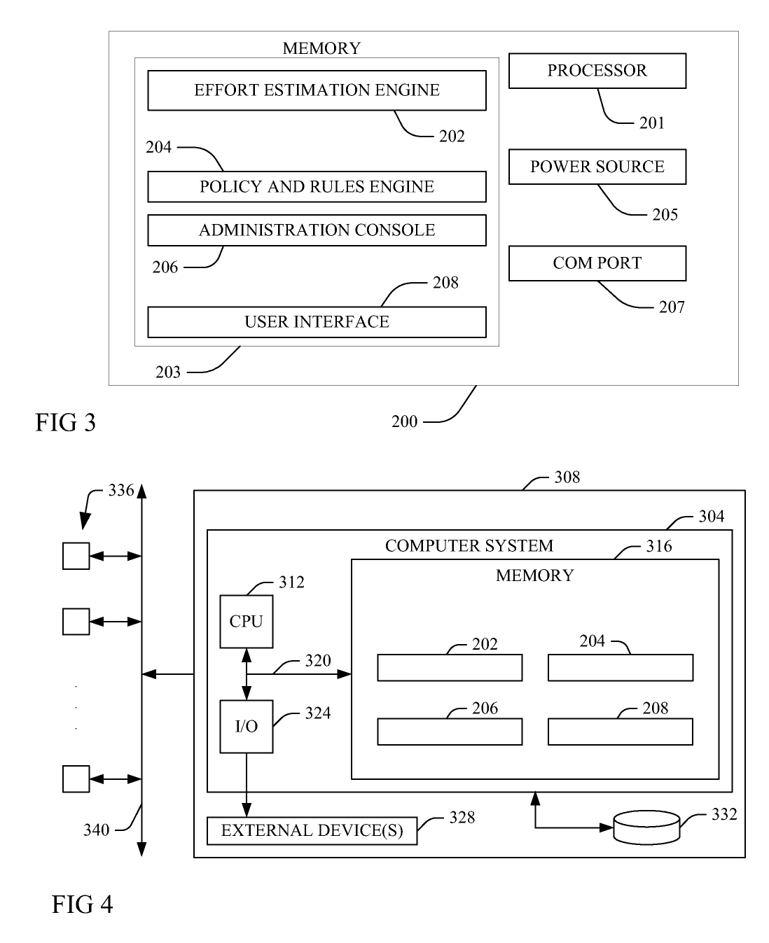

FIG. 3 illustrates a programmable device or module 200 configured to plan routes as a function of vehicle type according to the present invention, for example as illustrated in FIGS. 1 and 2 and described above. The device 200 may be incorporated into a larger system (such as one provided by a service provider) wherein other applications and components of the larger system accomplish systems and methods according to the present invention, or it may be a stand-alone device or module 200 configured to perform each of the systems and methods described above. The present embodiment comprises a central processing unit (CPU) or other processing means 201 in communication with a memory 203 comprising logic components that enable the CPU 201 to perform processes and methods according to the present application, as will be understood through reference to FIGS. 1 and 2 as discussed above. Thus, the memory 203 comprises an effort estimation engine logic component (e.g. algorithm, etc.) 202, a policy and rules engine logic component 204, an administration console logic component 206 and a user interface logic component 208. However, it will be understood that in other embodiments one or more of the logic components 202, 204, 206 and 208 may be omitted, and its functions or algorithms combined with others of the logic components 202, 204, 206 and 208 or accomplished by other systems, components, elements or parties.

A power source 205 is configured to provide operative power to the device 200; examples include battery units 205 and power inputs configured to receive alternating or direct current electrical power, and other appropriate power units 205 will be apparent to one skilled in the art. A communication port or network link/node means (“com port”) 207 is also provided and configured to enable data and other communications as may be appropriate, for example as discussed above.

### II. Computerized Implementation

Referring now to FIG. 4, an exemplary computerized implementation of the present invention includes a computer system 304 deployed within a computer infrastructure 308 such as a computer or a programmable device such as a personal digital assistant (PDA) or cellular phone. This is intended to demonstrate, among other things, that the present invention could be implemented within a network environment 340 (e.g., the Internet, a wide area network (WAN), a local area network (LAN), a virtual private network (VPN), etc.) in communication with one or more additional computers 336, or on a stand-alone computer infrastructure 308. In the case of the former, communication throughout the network 340 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

As shown, the computer system 304 includes a central processing unit (CPU) 312, a memory 316, a bus 320, and input/output (I/O) interfaces 324. Further, the computer system 304 is shown in communication with external I/O devices/resources 328 and storage media and systems 332 (e.g. a calibration information repository 110 or a calibration policies and rules repository 114 described above). In general, the processing unit 312 executes computer program code, such as the code to implement various components of the process and systems, and devices as illustrated in FIGS. 1-3 and described above, including the effort estimation engine logic component 202, the policy and rules engine logic component 204, the administration console logic component 206 and the user interface logic component 208 discussed above, and which are stored in memory 316 and/or storage system 332. It is to be appreciated that two or more, including all, of these components may be implemented as a single component.

While executing computer program code, the processing unit 312 can read and/or write data to/from the memory 316, the storage system 332, and/or the I/O interfaces 324. The bus 320 provides a communication link between each of the components in computer system 304. The external devices 328 can comprise any devices (e.g., keyboards, pointing devices, displays, etc.) that enable a user to interact with computer system 304 and/or any devices (e.g., network card, modem, etc.) that enable computer system 304 to communicate with one or more other computing devices.

The computer infrastructure 308 is only illustrative of various types of computer infrastructures for implementing the invention. For example, in one embodiment, computer infrastructure 308 comprises two or more computing devices (e.g., a server cluster) that communicate over a network to perform the various process steps of the invention. Moreover, computer system 304 is only representative of various possible computer systems that can include numerous combinations of hardware.

To this extent, in other embodiments, the computer system 304 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively. Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations.

Further, I/O interfaces 324 can comprise any system for exchanging information with one or more of the external device 328. Still further, it is understood that one or more additional components (e.g., system software, math co-processing unit, etc.) not shown in FIG. 4 can be included in computer system 304. However, if computer system 304 comprises a handheld device or the like, it is understood that one or more of the external devices 328 (e.g., a display) and/or the storage system 332 could be contained within computer system 304, not externally as shown.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN) or a storage area network (SAN) (not shown). In addition, although not shown, additional components, such as cache memory, communication systems, system software, etc., may be incorporated into computer system 304.

While shown and described herein as a method and a system, it is understood that the invention further provides various alternative embodiments. For example, in one embodiment, the invention provides a computer-readable/useable medium that includes computer program code to enable a computer infrastructure to implement methods, systems and devices according to the present application, for example as illustrated in FIGS. 1-4 above and described otherwise herein. To this extent, the computer-readable/useable medium includes program code that implements each of the various process steps of the present application.

It is understood that the terms computer-readable medium or computer useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 316 and/or the storage system 332 (e.g., a fixed disk, a read-only memory, a random access memory, a cache memory, etc.), and/or as a data signal (e.g., a propagated signal) traveling over a network (e.g., during a wired/wireless electronic distribution of the program code).

Still yet, computer infrastructure 308 is intended to demonstrate that some or all of the components of implementation according to the present application could be deployed, managed, serviced, etc. by a service provider who offers to implement, deploy, and/or perform the functions of the present invention for others, for example by licensing methods and browser or application server technology to an internet service provider (ISP) or a cellular telephone provider. In one embodiment, the invention may comprise a business method that performs the process steps of the invention on a subscription, advertising, and/or fee basis. Thus, a service provider can create, maintain, support, etc., a computer infrastructure, such as the computer infrastructure 308 that performs the process steps of the present application for one or more customers, and in return the service provider can receive payment from the customer(s) under a subscription and/or fee agreement and/or the service provider can receive payment from the sale of advertising content to one or more third parties.

In still another embodiment, the invention provides a computer-implemented method for enabling the processes, methods and devices according to the present application. In this case, a computer infrastructure, such as computer infrastructure 308, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer system 304, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

Certain examples and elements described in the present specification, including in the claims and as illustrated in the Figures, may be distinguished or otherwise identified from others by unique adjectives (e.g. a “first” element distinguished from another “second” or “third” of a plurality of elements, a “primary” distinguished from a “secondary,” an “another”, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for calibrating and customizing an estimation model as a function of a service-oriented architecture environment, comprising:
providing a programmable calibration engine device configured by a logic component;
the calibration engine generating a service-oriented architecture solution effort estimate as a function of a business available resource input and a required business functionality input.

2. The method of claim 1, further comprising:
managing a calibration constraint, a policy, an end-user access control, an output scope and an output format; and
providing a programmable effort estimation engine device; and
wherein the calibration engine generating the service-oriented architecture solution effort estimate comprises:
providing a set of a predefined constraint, a boundary value and historical calibration data to the effort estimation engine; and
the effort estimation engine generating the service-oriented architecture solution effort estimate as a function of the provided set, the policy and an input of a solution parameter within the scope of a service-oriented architecture transformation.

3. The method of claim 2 wherein the predefined constraint comprises at least one of a number of business processes, a number of business units, a budget, a skilled resource and a project duration.

4. The method of claim 3, further comprising:
providing a policy and rules engine in communication with the effort estimation engine;
the policy and rules engine leveraging the policy and delivering a leveraged policy to the effort estimation engine on demand.

5. The method of claim 4, further comprising:
providing a calibration information repository in communication with the effort estimation engine; and
the calibration information repository communicating the set of the predefined constraint, the boundary value and the historical calibration data to the effort estimation engine.

6. The method of claim 5, further comprising providing a programmable administration console in communication with the effort estimation engine for the managing the calibration constraint, the policy, the end-user access control, the output scope and the output format.

7. The method of claim 6, further comprising:
providing an interactive user interface module in communication with the effort estimation engine, the interactive user interface module configured to receive an end-user input of the solution parameter within the scope of the service-oriented architecture transformation.

8. The method of claim 1, further comprising a service provider deploying at least one of the programmable calibration engine device and the logic component.

9. The method of claim 8, further comprising:
the service provider managing a calibration constraint, a policy, an end-user access control, an output scope and an output format; and
the service provider providing a programmable effort estimation engine device; and
wherein the calibration engine generating the service-oriented architecture solution effort estimate comprises:
providing a set of a predefined constraint, a boundary value and historical calibration data to the effort estimation engine; and
the effort estimation engine generating the service-oriented architecture solution effort estimate as a function of the provided set, the policy and an input of a solution parameter within the scope of a service-oriented architecture transformation; and
wherein the predefined constraint comprises at least one of a number of business processes, a number of business units, a budget, a skilled resource and a project duration.

10. The method of claim 9, further comprising:
the service provider providing a policy and rules engine in communication with the effort estimation engine;
the policy and rules engine leveraging the policy and delivering a leveraged policy to the effort estimation engine on demand.

11. The method of claim 10, further comprising:
providing a calibration information repository in communication with the effort estimation engine; and
the calibration information repository communicating the set of the predefined constraint, the boundary value and the historical calibration data to the effort estimation engine.

12. A method for calibrating and customizing an estimation model as a function of a service-oriented architecture environment, comprising:
producing computer executable program code;
storing the code on a computer readable medium; and
providing the program code to be deployed and executed on a computer system, the program code comprising instructions which, when executed on the computer system, cause the computer system to:
provide a calibration engine; and
cause the calibration engine to generate a service-oriented architecture solution effort estimate as a function of a business available resource input and a required business functionality input.

13. The method of claim 12, the program code comprising instructions which, when executed on the computer system, further causes the computer system to:
manage a calibration constraint, a policy, an end-user access control, an output scope and an output format;
provide a programmable effort estimation engine device;
provide a set of a predefined constraint, a boundary value and historical calibration data to the effort estimation engine; and
cause the effort estimation engine to generate the service-oriented architecture solution effort estimate as a function of the provided set, the policy and an input of a solution parameter within the scope of a service-oriented architecture transformation; and
wherein the predefined constraint comprises at least one of a number of business processes, a number of business units, a budget, a skilled resource and a project duration.

14. The method of claim 13, the program code comprising instructions which, when executed on the computer system, further causes the computer system to:
provide a policy and rules engine in communication with the effort estimation engine; and
cause the policy and rules engine to leverage the policy and deliver a leveraged policy to the effort estimation engine on demand.

15. The method of claim 14, the program code comprising instructions which, when executed on the computer system, further causes the computer system to:
cause a calibration information repository in communication with the effort estimation engine to communicate the set of the predefined constraint, the boundary value and the historical calibration data to the effort estimation engine.

16. A programmable device comprising:
a processing means;
a memory in communication with the processing means comprising a logic component; and
a network interface in communication with the processing means and the memory;
wherein the processing means is configured to:
provide a calibration engine; and
cause the calibration engine to generate a service-oriented architecture solution effort estimate as a function of a business available resource input and a required business functionality input.

17. The programmable device of claim 16, wherein the processing means is further configured to:
manage a calibration constraint, a policy, an end-user access control, an output scope and an output format;
provide a programmable effort estimation engine device;
provide a set of a predefined constraint, a boundary value and historical calibration data to the effort estimation engine; and
cause the effort estimation engine to generate the service-oriented architecture solution effort estimate as a function of the provided set, the policy and an input of a solution parameter within the scope of a service-oriented architecture transformation; and
wherein the predefined constraint comprises at least one of a number of business processes, a number of business units, a budget, a skilled resource and a project duration.

18. The programmable device of claim 17, wherein the processing means is further configured to:
provide a policy and rules engine in communication with the effort estimation engine; and
cause the policy and rules engine to leverage the policy and deliver a leveraged policy to the effort estimation engine on demand.

19. The programmable device of claim 20, wherein the processing means is further configured to:
cause a calibration information repository in communication with the effort estimation engine to communicate the set of the predefined constraint, the boundary value and the historical calibration data to the effort estimation engine.

20. The programmable device of claim 19, wherein the processing means is further configured to:
provide an administration console in communication with the effort estimation engine for the managing the calibration constraint, the policy, the end-user access control, the output scope and the output format in response to an end-user input.
